(19) United States
(12) Patent Application Publication
(10) Pub. No.: US 2015/0233131 A1
(43) Pub. Date: Aug. 20, 2015

(54) Stair Measuring Apparatus

(71) Applicant: Peter Hofstetter, Mitchelton (AU)

(72) Inventor: Peter Hofstetter, Mitchelton (AU)

(21) Appl. No.: 14/180,467

(22) Filed: Feb. 14, 2014

(51) Int. Cl. E04F 21/26; G01B 3/04

(52) U.S. Cl. CPC E04F 21/26; G01B 3/04

(57) ABSTRACT

An apparatus to measure the rise and going of steps in stair has a first ruler member that is positionable on a tread. A first indicator is provided that is slideably attached to the first rule member and positionable against an outer edge of the tread. The first indicator enables the going of the tread to be measured. A second ruler member is also provided that is positionable adjacent a riser extending from an inner edge of the tread, and. A second indicator is slideably attached to the second ruler member and positionable on an adjacent tread to enable the rise of the step to be measured. In use the apparatus allows for the rapid checking of steps to determine their compliance with relevant building regulations.

### TECHNICAL FIELD

The present invention is directed to a measuring tool to enable a person to determine if stairs comply with the building code, relevant standard or other regulatory requirements.

### BACKGROUND

Any references to methods, apparatus or documents of the prior art are not to be taken as constituting any evidence or admission that they formed, or form part of the common general knowledge.

Stairway, staircase, stairwell, flight of stairs, or stairs are names for a construction designed to bridge a large vertical distance by dividing it into smaller vertical distances, called steps.

In Australia, and also in the USA, there are building regulations covering steps and stairs. In Australia the Building Code of Australia BCA 2012 clause D2.13 sets forth detailed requirements for steps, stairs, landings, guard rails and so on. These include:

A stairway must have—not more than 18 nor less than 2 risers in each flight; and
(ii) except as permitted by (b) and (c), going (G), riser (R) and quantity (2R+G) in accordance with Table D2.13; and
(iii) except as permitted by (b) and (c), goings and risers that are constant throughout in one flight; and
(iv) risers which do not have any openings that would allow a 125 mm sphere to pass through between the treads; and
(v) treads which have a non-slip finish or an adequate non-skid strip near the edge of the nosings; and
(vi) treads of solid construction (not mesh or other perforated material) if the stairway is more than 10 m high or connects more than 3 storeys; and
(vii) in a Class 9b building, not more than 36 risers in consecutive flights without a change in direction of at least 30°; and
(viii) in the case of a required stairway, no winders in lieu of a landing.

Slipping, tripping or falling are risks that can be associated with steps and stairs, and can lead to serious injuries. Under s21 of the 2004 OHS Act (Occupational Health and Safety), the employer has a duty of care to provide and maintain a safe and healthy workplace—all potential hazards must be identified, the associated risk assessed and then controls introduced to eliminate or reduce those risks as far as practicable.

Also under the Act (s26), persons who ‘manage or control’ workplaces must ensure that the workplace and the means of entering and leaving it are safe and without risks to health.

Similarly, in the U.S.A. the Department of Labor sets forth regulations and standards that govern the requirements for stairs and in particular for the angle of stairway rise, which is a function of the stairs rise and run dimensions.

To avoid costly compensation claims and litigation, it is necessary to ensure that stairs strictly comply with the codes. Thus inspections of newly built stairs, most frequently in brand new buildings are carried out. It is also known to perform inspections of old stairs and stairs in newly purchased properties to ensure that they comply. The stairs can comprise indoor or outdoor stairs.

Inspection requires at least the measurement of the height and depth of each tread, and sometimes the levelness of each tread. Clearly, for large stairs this can be a time consuming exercise.

The parts of a stair are illustrated in FIG. 1. The stair comprises two main parts being the horizontal tread and the vertical rise/riser. The tread has a width and a depth. The depth of the tread is the measurement from the front outer edge to the rear inner edge. The “going” of the tread is the measurement from the outermost edge of one tread to the outermost edge of the adjacent tread. If the steps have an extending nose (see FIG. 1), the going is the measurement from the nose of one step to the nose (or outer edge) of the next step.

It is an object of the present invention to provide an apparatus that can quickly and accurately measure stair dimensions to see if the stairs comply with required regulations.

### SUMMARY OF THE INVENTION

According to a first aspect of the present invention there is provided an apparatus to measure the height and going of steps in a stair, the apparatus comprising:
a first ruler member positionable on a tread,
a first indicator moveably attached to the first ruler member and positionable against an outer edge of the tread to enable the going of the tread to be measured,
a second ruler member positionable adjacent a riser extending from an inner edge of the tread, and,
a second indicator moveably attached to the second ruler member and positionable on an adjacent tread.

In this manner, the apparatus can be placed on the tread of a step and the indicators can be moved (typically by sliding) until one indicator is against the outer edge of a tread and the other indicator is on the top of an adjacent tread. The measurement of the going and the rise of each step can be quickly read off each ruler member.

The apparatus does not need to be powered and does not need to contain any complicated parts and components. It is no longer necessary to separately measure the going and the rise of a particular step. Instead, the apparatus enables both to be measured together.

Another advantage of the apparatus is that it can readily accommodate steps that have extending portions (e.g. a bullnose) as the apparatus can be simply pushed up against the extending portion. This is much more convenient then using a flexible tape measure.

The apparatus is preferably substantially L shaped in configuration to define two legs, with the first ruler member comprising one of the legs and the second ruler member comprising the other of the legs. Typically, the first ruler member and the second ruler member will be at right angles relative to each other.

It is preferred that the first ruler member and the second ruler member are rigidly attached relative to each other. In one form, the first ruler member and the second ruler member can be manufactured from a single piece of material. However, there may be circumstances where it is convenient for the first ruler member and the second ruler member to be formed separately and attached to each other by any suitable means. Thus, there may be circumstances where it is desirable that the first ruler member and the second ruler member be movable between a folded storage position where the two members are substantially in alignment, and an extended use position where the first ruler member and the second ruler member are substantially at right angles relative to each other and are preferably locked into that position.

If the apparatus is to be used consistently on stairs that must have the same measurements, there may be an advantage in precisely defining the length of each ruler member such that the apparatus cannot be used in respect of any stair that exceeds the required measurements.

This may provide a very quick the initial check to see if a particular step exceeds particular measurements. However, there is no requirement for the invention to be limited to this particular embodiment.

It may be advantageous to provide extension members on the first ruler and the second ruler to enable the apparatus to be used on different types of steps which may have different measurement requirements. In this embodiment, the apparatus may have a first size suitable for most steps but if larger measurements need to be made, the extension members can be added to provide a larger apparatus. Again, there is no requirement for the invention to be limited to this particular embodiment.

It is preferred that each ruler member is substantially plate like in configuration. As an example, each ruler member may have a length as previously described and may have a width of between 10-50 mm to provide sufficient rigidity and sufficient space to allow the respective indicator members to be attached and to allow the required indicia to be clearly visible.

The apparatus may be made of any suitable material. It is envisaged that the apparatus will be made of metal such as steel but the apparatus may also be made of aluminium, brass, other metals, metal alloys, plastics materials, laminate materials, wood, fiberglass and the like. It is not envisaged that any unnecessary limitation should be placed on the materials of which the apparatus may be made.

Although it is preferred that the apparatus is substantially plate like in configuration, there may be circumstances where it is advantageous for the first ruler member and/or the second ruler member to have other configurations. For instance, there may be an advantage for the ruler members to have a box like cross-section. There may be an advantage for the ruler members to be substantially L-shaped in cross-section (for instance to enable the apparatus to be self-supporting on the surface and not tip over). There may be an advantage in providing extending tab members or other members to enable the apparatus to be self-supporting.

Each ruler member is preferably contains measuring indicia. This will typically comprise a metric scale (or an imperial scale), or both. The indicia may be located entirely along each ruler member or along only part of each ruler member. The indicia may be located on one side of each ruler member or on more than one side of each ruler member. The indicia may be applied by any suitable means. For instance, the indicia may be etched into each ruler member or stamped into each ruler member. Alternatively, the indicia may be printed or otherwise provided on a separate member which may be fastened to the ruler member by any suitable means such as the use of adhesive, or separate fasteners.

Each ruler member is provided with an indicator. It is preferred that each ruler member contains a single indicator. The indicator may comprise an extending member or projection which extends from the respective ruler member. The extending member/projection may comprise a finger. The finger may be plate like, rod like, L-shaped, tubular, and the like although in a particularly preferred embodiment, the finger will comprise a plate like member.

The length of the extending portion of the finger should be sufficient to enable it to be positionable either against an outer edge of the tread or the rise or on a tread (depending on the particular finger). Therefore, it is considered that a suitable length of the finger will be between 20-100 mm although this can vary to suit. The finger member may be manufactured from material similar to that of the remainder of the apparatus and therefore, in a preferred embodiment, the finger member is made of metal. The finger member should be sufficiently rigid such that it can make the required measurements without deforming.

Each indicator is movably attached to the respective ruler member. It is preferred that each indicator can slide relative to its respective ruler member. In one nonlimiting embodiment, one or both of the indicators can be substantially L shaped in configuration with the finger member comprising one of the extending L-shaped portions and the other portion comprising a further member which can move relative to the ruler member and can be fixed thereto at a desirable position. In this manner, the finger member can be operatively attached to the ruler member by being part of the L-shaped portion.

Various alternatives are envisaged as to how the indicators can be attached relative to the ruler members. In a nonlimiting embodiment the, or each, indicator can comprise some form of projection or projections which can be captured in one or more slots or recesses in the respective ruler.

If the ruler members comprise box sections, the indicators may be telescopically extendible and retractable relative to the ruler member.

At least one of the projections may be threaded to therefore comprise a bolt, and a nut (for instance a wing nut) can be threaded to the bolt to lock the respective indicator to the ruler member. Suitably, each of the projections comprise a similar bolt.

It is preferred that the indicators and the ruler members are magnetically attracted to each other. In this manner, a particular indicator can be slid along a respective ruler member and held to the ruler member by magnetic attraction. When the indicator is in the desired measurement position, it can be locked, for instance, by the nuts and bolts as described above. Of course, this is a preferred embodiment only.

The apparatus may comprise further attachments or parts to assist in measuring stairs. As an example, the apparatus may include a level indicator to ensure that a particular tread is substantially horizontal. The level indicator may comprise a spirit level. The level indicator may be attached to the first ruler by any suitable means.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1. Illustrates schematically the major parts of a stair.

FIG. 2. Illustrates the apparatus in use and viewed from one side.

FIG. 3. Illustrates the other side of the apparatus.

FIG. 4. Illustrates an “exploded” view of the apparatus.

### DETAILED DESCRIPTION OF PREFERRED EMBODIMENTS

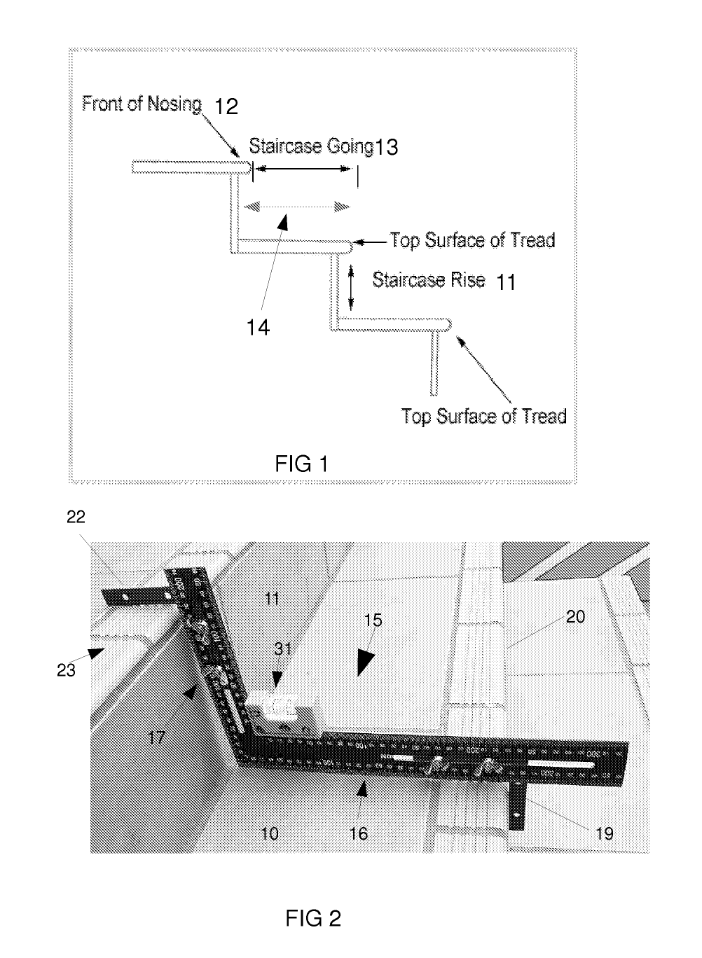

Referring initially to FIG. 1, there is illustrated, schematically, parts of a stair. The stair comprises a number of steps. Each step comprises a tread 10 and a rise 11. In the particular figure, the tread has an outer edge formed with a projecting nosing 12. The “going” 13 of each tread is the distance between the edge of nosing 12 of one tread to the edge of nosing 12 of the next tread. The depth 14 of each tread is the measurement from the outer edge of a particular tread to the inner rise of the same tread.

In Australia and also in the USA there are quite strict regulations that dictate the rise and going (or as it is also known “the run”) of each tread, and costly litigation and compensation can occur if stairs do not comply with the regulations.

The apparatus of the present invention enables stairs to be very quickly and reliably measured to see if individual steps comply with the regulations. If not, the apparatus can also determine how far out the measurements are.

Referring now to FIGS. 2-4 there is illustrated the apparatus 15 according to an embodiment of the invention. The apparatus basically comprises:

(a) a first ruler member 16 positionable on a tread 10,
(b) a first indicator 18 having a finger 19 moveably attached to the first ruler member 16 and positionable against an outer edge 20 of the tread to enable the going of the tread to be measured,
(c) a second ruler member 17 positionable adjacent a riser 11 extending from an inner edge of the tread 10, and,
(d) a second indicator 21 having a finger 22 moveably attached to the second ruler member 17 and positionable on an adjacent tread 23.

The first ruler member 16 and the second ruler member 17 comprise a unitary L-shaped metal plate like member. Each ruler member 16, 17 comprises measurement indicia which, in the particular embodiment, comprises a metric scale though it may also be set out in imperial measurements.

Each ruler member may have a length suitable to enable a step to be properly measured. As it is envisaged that the going of a step will typically be between 8.4 inches to 14 inches (i.e. 215-355 mm), it is envisaged that the first ruler member will be at least 14 inches (355 mm) long and will typically be about 14.5 inches (370 mm) long. As it is envisaged that the rise of a step will typically be between 4.5 inches to 8.5 inches (115-215 mm), it is envisaged that the second ruler member will have a length of between 9 inches to 9.8 inches (230-250 mm). These ruler member lengths can of course be varied in other embodiments of the invention. The invention is not limited to specific ruler member lengths other than that they be of suitable length for the stairs to be measured.

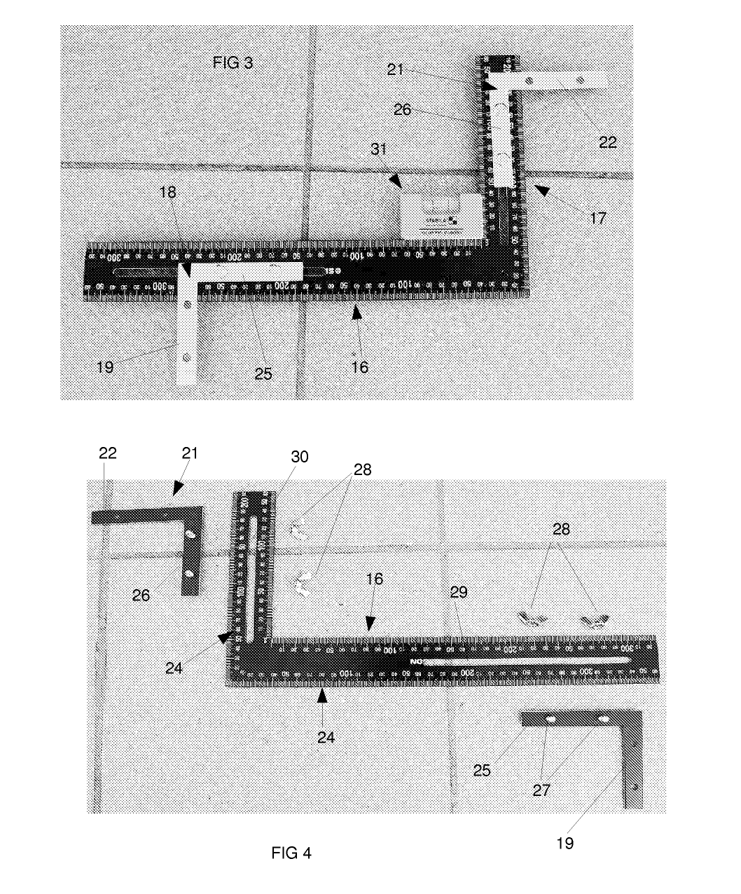

Each indicator 18, 21 comprises a unitary L-shaped metal plate like member with one extension comprising the respective finger 19, 22 and the other extension comprising a further member 25, 26 which extends along the respective ruler member. Each further member 25, 26 (see particularly FIG. 4) comprises a pair of spaced apart short projections in the form of bolts 27 to which wing nuts 28 can be attached.

Each ruler member 16, 17 is formed with a slot 29, 30 (see particularly FIG. 4). The bolts 27 are trapped in a respective slot 29, 30 which enables the respective indicator 18, 21 to have limited sliding movement relative to the respective ruler member 16, 17.

The apparatus and the indicators 18, 21 are magnetic. Thus, each indicator can be easily moved relative to its respective ruler member to the desired measuring position and can then be held in position by magnetic attraction. The nuts can then be tightened to firmly lock the indicator in place such that the measurements can be properly read from the indicia 24. This enables the indicators to be adjusted without needing to loosen and tighten the respective bolts every time.

A spirit level 31 can be attached to the first ruler member 16 to make sure that each tread is horizontal.

### USE FOR THE INVENTION

In use, the indicators 18, 21 can be loosened and pulled back to the extreme edges of the respective slots. The apparatus can then be placed on a step in the manner illustrated in FIG. 2. The indicators can then be slid until they abut against the respective step portions and can be loosely held by magnetic attraction. The indicators can then be locked by tightening the wing nuts 28. The apparatus can then be removed and the measurements can be read off the particular ruler members to see if the step complies with the regulations.

The above description identifies at least one specific, substantial and credible use for the invention.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

1. An apparatus to check the rise and going of steps in an existing stair, the apparatus comprising:
a first ruler member positionable on a tread, with
a first indicator moveably attached to, and able to slide along the length of, the first ruler member; and having a finger, held at right angles to the first ruler member, positionable against an outer edge of the tread to enable the going of the tread to be measured.
a second ruler member positionable adjacent a riser extending from an inner edge of the tread, with
a second indicator moveably attached to, and able to slide along the length of, the second ruler member; and
having a finger, held at right angles to the second ruler member, positionable on an adjacent tread to enable the rise of the tread to be measured,
the first indicator member and the second indicator member being moveable independently of each other,
the first ruler member and the second ruler member being attached to each other at right angles in a non-slideable manner.

2. The apparatus of claim 1, wherein the first ruler member and the second ruler member define a substantially L shaped configuration.

3. The apparatus of claim 1, wherein each ruler member is substantially plate like.

4. The apparatus of claim 1, wherein each ruler member comprises measurement indicia on at least one side face of the ruler member.

5. (canceled)

6. (canceled)

7. The apparatus as claimed in claim 1, wherein each said indicator comprises a said finger member extendible from the said ruler member and comprises a further member slideable along the said ruler member and fixable thereto to slideable attach the said indicator to the said ruler member.

8. (canceled)

9. The apparatus as claimed claim 1, wherein each said indicator is releasably lockable to the respective ruler member.

10. The apparatus as claimed in claim 1, wherein each said indicator is magnetically attachable relative to the respective ruler member.

11. The apparatus as claimed in claim 1, including a level indicating means.

12. The apparatus of claim 11, wherein the level indicating means is attachable to the first ruler member.

13. The apparatus as claimed claim 1, wherein each indicator is slideably moveably along the respective ruler member.
